(19) United States
(12) Patent Application Publication
(10) Pub. No.: US 2018/0286547 A1
(43) Pub. Date: Oct. 4, 2018

(54) SOFT MAGNETIC ALLOY

(71) Applicant: LG INNOTEK CO., LTD., Seoul (KR)

(72) Inventors: So Yeon KIM, Seoul (KR); Seok BAE, Seoul (KR); Jai Hoon YEOM, Seoul (KR); Sang Won LEE, Seoul (KR); Jong Soo HAN, Seoul (KR); Hyo Yun JUNG, Seoul (KR)

(21) Appl. No.: 15/767,576

(22) PCT Filed: Oct. 14, 2016
(86) PCT No.: PCT/KR2016/011564

§ 371 Date: Apr. 11, 2018

(30) Foreign Application Priority Data
Oct. 20, 2015 (KR) 10-2015-0146232

(51) Int. Cl. H01F 1/153; H01F 1/147; H01Q 1/52; C22C 45/02; C22C 38/02

(52) U.S. Cl. CPC H01F 1/15308; H01F 1/14775; H01Q 1/526; C22C 45/02; H01F 41/0226; C22C 2200/02; C22C 2200/04; C22C 2202/02; C22C 38/02

(57) ABSTRACT

A soft magnetic alloy according to an embodiment of the present invention has a composition of Formula below:

FeₐX_{b}Y_{c}Z_{d} [Formula]
wherein, in the above Formula, X includes at least one of silicon (Si) and phosphorus (P), Y includes carbon (C), Z includes at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

### TECHNICAL FIELD

The present invention relates to a soft magnetic alloy, and more particularly, to an amorphous or nanocrystalline soft magnetic alloy.

### BACKGROUND ART

Recently, there is a growing demand for the use of high performance soft magnetic materials in a variety of electronic devices such as computers, machines, and communication devices. Thus, to realize physical properties that cannot be provided by existing materials such as silicon steel and ferrite, the use of high-performance soft magnetic metal materials is highly required. Soft magnetic metal materials having high saturation magnetic flux density, high magnetic permeability, and resistivity characteristics may be used for general purposes, and it is possible to realize characteristics such as small sizes, light weights, and low loss by replacing existing components. Specifically, high performance soft magnetic materials may be applied to soft magnetic cores such as inductors, choke coils, and transformers, and various sheets for shielding electromagnetic fields.

Up to now, Fe-based amorphous alloys have mainly been used to meet the requirement for high saturation flux density characteristics. Among them, when higher saturation flux density and superior amorphous characteristics are required, Fe—Si—B ternary soft magnetic alloys are applied. For this, in addition to Fe, a metalloid element and an additional metal element should be contained in a predetermined amount or more. However, as the metalloid element and the additional metal element are included in larger amounts, Fe should be included in a relatively smaller amount, and thus saturation magnetic flux density tends to be 165 emu/g or less. Therefore, such a Fe—Si—B soft magnetic alloy has a limitation in being applied to environmentally friendly automobiles and high-performance electronic devices which require high saturation magnetic flux density.

### DISCLOSURE

### Technical Problem

An object of the present invention is to provide an amorphous or nanocrystalline soft magnetic alloy having high saturation magnetic flux density.

### Technical Solution

A soft magnetic alloy according to an embodiment of the present invention has a composition of Formula below:

FeₐX_{b}Y_{c}Z_{d} [Formula]

wherein, in the above Formula, X includes at least one of silicon (Si) and phosphorus (P), Y includes carbon (C), Z includes at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

The Si may be included in an amount of 2 at % to 8 at %.

The P may be included in an amount of 2 at % to 8 at %.

The Z may include B.

The Z may further include Al.

The Z may further include Co.

The Z may further include Cr.

The soft magnetic alloy according to an embodiment of the present invention may have a saturation magnetic flux density of 170 emu/g or more.

The soft magnetic alloy according to an embodiment of the present invention may be amorphous or nanocrystalline.

A method of forming a soft magnetic core, according to an embodiment of the present invention, includes: preparing a molten solution by mixing and melting powder having a composition of Formula below; forming a ribbon by cooling the molten solution; heat-treating the ribbon; and forming a soft magnetic core by winding the heat-treated ribbon.

FeₐX_{b}Y_{c}Z_{d} [Formula]

wherein, in the above Formula, X includes at least one of silicon (Si) and phosphorus (P), Y includes carbon (C), Z includes at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

The molten solution may be cooled by spraying a gas including at least one of N₂ and Ar, or water.

### Advantageous Effects

According to an embodiment of the present invention, a soft magnetic alloy having excellent amorphous or nanocrystalline formability and a saturation magnetic flux density of 170 emu/g or more can be obtained. The soft magnetic alloy according to an embodiment of the present invention can be applied to wireless power transmitters/receivers for wireless charging, RFID tags, various shielding sheets, transformers, inductors, choke coils, and the like.

### DESCRIPTION OF DRAWINGS

FIG. 1 illustrates a transformer including a soft magnetic core according to an embodiment of the present invention.

FIG. 2 illustrates a soft magnetic core formed by winding an amorphous or nanocrystalline ribbon made of a soft magnetic alloy according to an embodiment of the present invention.

FIG. 3 is a partial view of a wireless power transmitter according to an embodiment of the present invention.

FIG. 4 is a partial view of a wireless power receiver according to an embodiment of the present invention.

FIG. 5 is a flowchart illustrating a method of preparing a soft magnetic alloy, according to an embodiment of the present invention.

FIG. 6 is a thermal analysis graph of a soft magnetic alloy prepared according to Example 1.

FIG. 7 illustrates X-ray diffraction (XRD) pattern analysis of the soft magnetic alloy of Example 1.

FIG. 8 illustrates the saturation magnetic flux density of Example 1.

### MODE OF THE INVENTION

As the present invention allows for various changes and numerous embodiments, particular embodiments will be illustrated in the drawings and described in detail. However, this is not intended to limit the present invention to particular modes of practice, and it is to be appreciated that all changes, equivalents, and substitutes that do not depart from the spirit and technical scope of the present invention are encompassed in the present invention.

Although terms including ordinal numbers, such as “first,” “second,” and the like, may be used to describe various components, such components must not be limited by the above terms. The above terms are used only to distinguish one component from another. For example, a first element can be named a second element, and similarly, the second element can be named the first element without departing from the scope of the present invention. The term “and/or” includes any and all combinations of one or more of the associated listed items.

When it is described that a certain element is “connected” or “linked” to another element, it should be understood that the certain element may be connected or linked to the other element directly or via another element present therebetween. In contrast, when a certain element is “directly connected” or “directly linked” to another element, it should be understood that there are no other elements present therebetween.

The terminology used in the application is used only to describe specific embodiments and is not intended to limit the present invention. An expression in the singular includes an expression in the plural unless the content clearly indicates otherwise. In the application, it should be understood that terms, such as “include” and “have”, are used to indicate the presence of stated features, numbers, steps, operations, elements, parts, or a combination thereof without excluding in advance the possibility of the presence or addition of one or more other features, numbers, steps, operations, elements, parts, or combinations thereof.

All terms used herein including technical or scientific terms have the same meaning as those generally understood by those of ordinary skill in the art unless otherwise defined. It should be understood that terms generally used, which are defined in a dictionary, have the same meaning as in the context of the related art, and the terms are not interpreted with an ideal or excessively formal meaning unless otherwise clearly defined in the application.

Hereinafter, embodiments will be described in detail with reference to the accompanying drawings, wherein the like or corresponding elements denote the like reference numerals, and redundant description thereof will be omitted.

A soft magnetic alloy according to an embodiment of the present invention may be applied to soft magnetic cores such as inductors, choke coils, transformers, and the like, and various sheets for shielding electromagnetic fields. For example, the soft magnetic alloy according to an embodiment of the present invention may also be applied to a soft magnetic core for a transformer, a soft magnetic core for a motor, or a magnetic core for an inductor. The soft magnetic alloy according to an embodiment of the present invention may be applied to a magnetic core in which a coil is wound or a magnetic core in which a wound coil is accommodated. When amorphous or nanocrystalline powder having high saturation magnetic flux density is used as a magnetic core of a transformer, an inductor, or the like, the magnetic core may be more lightweight than existing materials, and characteristics such as a low energy loss, i.e., high energy efficiency, due to excellent resistivity characteristics may be achieved. Accordingly, a magnetic core in an electronic device may be small-sized and lightweight and have high efficiency. Meanwhile, when amorphous or nanocrystalline powder is used as a magnetic sheet for shielding, the magnetic sheet has a smaller thickness and an increased shielding efficiency, and thus it is easy to achieve a light weight and high efficiency of a wireless charging device.

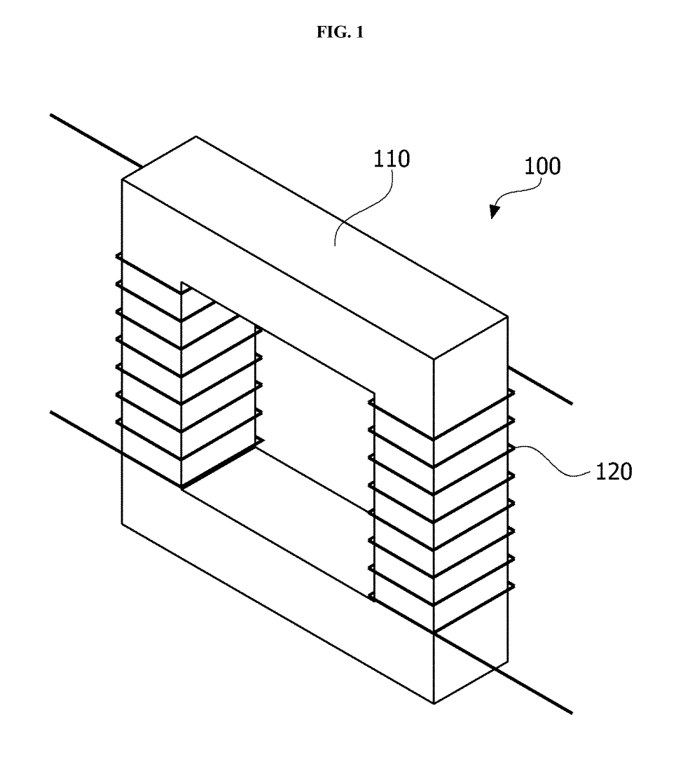

FIG. 1 illustrates a transformer 100 including a soft magnetic core according to an embodiment of the present invention.

Referring to FIG. 1, the transformer 100, which is configured to change an alternating voltage by electromagnetic induction, includes a soft magnetic core 110 and coils 120 wound on opposite sides of the soft magnetic core 110. Since a change in the magnetic field that is generated when an alternating current is input to a primary coil affects a secondary coil through the soft magnetic core 110, magnetic flux of the secondary coil is changed and, accordingly, a current is induced in the secondary coil. In this regard, the soft magnetic core 110 may be molded using the soft magnetic alloy according to an embodiment of the present invention, or may be formed by winding an amorphous or nanocrystalline ribbon made of the soft magnetic alloy according to an embodiment of the present invention.

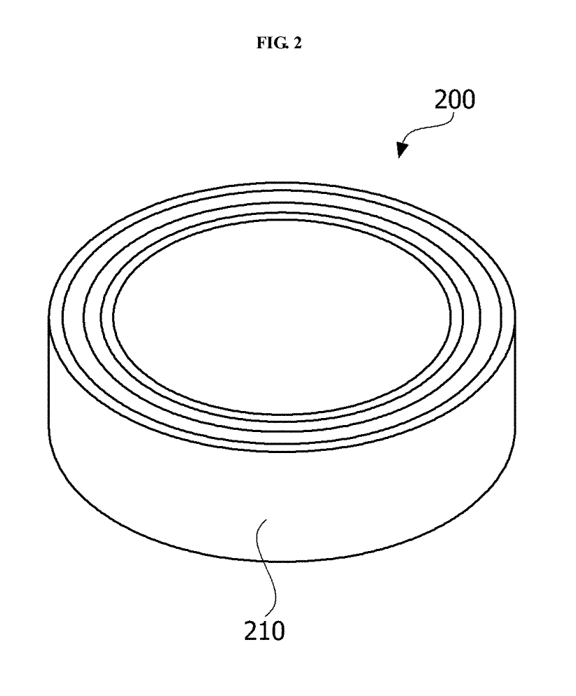

FIG. 2 illustrates a soft magnetic core 200 made of the soft magnetic alloy according to an embodiment of the present invention.

Referring to FIG. 2, the soft magnetic core 200 may be formed by winding an amorphous or nanocrystalline ribbon 210 made of the soft magnetic alloy according to an embodiment of the present invention. The soft magnetic core 200 may be applied to a transformer, a motor, an inductor, and the like.

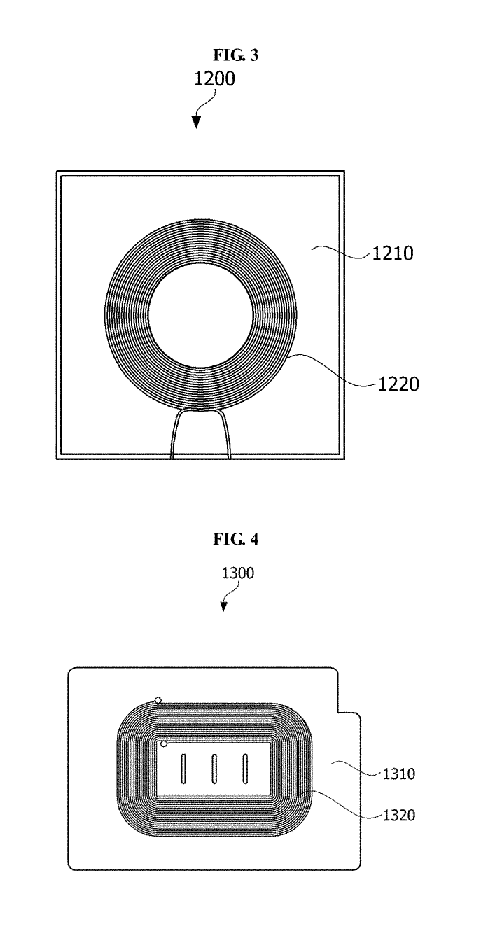

FIG. 3 is a partial view of a wireless power transmitter 1200 according to an embodiment of the present invention. FIG. 4 is a partial view of a wireless power receiver 1300 according to an embodiment of the present invention.

Referring to FIG. 3, the wireless power transmitter 1200 includes a soft magnetic core 1210 and a permanent magnet 1220.

The soft magnetic core 1210 may consist of a soft magnetic material having a thickness of several millimeters. The soft magnetic core 1210 may be molded using the soft magnetic alloy according to an embodiment of the present invention, or may be formed by winding an amorphous or nanocrystalline ribbon made of the soft magnetic alloy according to an embodiment of the present invention. In addition, the transmitter coil 1220 may be disposed on the soft magnetic core 1210. Although not shown in the drawing, a permanent magnet may be further disposed on the soft magnetic core 1210, and the permanent magnet may be surrounded by the transmitter coil 1220.

Referring to FIG. 4, the wireless powder receiver 1300 includes a soft magnetic substrate 1310 and a receiver coil 1320, and the receiver coil 1320 may be disposed on the soft magnetic substrate 1310.

The receiver coil 1320 may consist of coil surfaces, on the soft magnetic substrate 1310, wound in parallel to the soft magnetic substrate 1310. The soft magnetic substrate 1310 may be molded using the soft magnetic alloy according to an embodiment of the present invention, or may be formed by winding an amorphous or nanocrystalline ribbon made of the soft magnetic alloy according to an embodiment of the present invention.

Although not shown in the drawing, when the wireless power receiver 1300 has both a wireless charging function and a near field communication (NFC) function, an NFC coil may further be mounted on the soft magnetic substrate 1310. The NFC coil may be formed so as to surround an outer side of the receiver coil 1320.

According to one embodiment of the present invention, a soft magnetic core of a transformer, a motor, and an inductor, a soft magnetic core of a wireless power transmitter, a soft magnetic substrate of a wireless power receiver, and the like include a soft magnetic alloy having a composition of Formula 1 below:

FeₐX_{b}Y_{c}Z_{d} [Formula 1]

wherein, in Formula 1, X includes at least one of silicon (Si) and phosphorus (P), Y includes carbon (C), Z includes at least one element of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, preferably 4 at % to 12 at %, and more preferably 8 at % to 10 at %, c ranges from 2 at % to 8 at %, preferably 4 at % to 8 at %, and d ranges from 0.25 at % to 10 at %, preferably 2 at % to 8 at %, and more preferably 4 at % to 8 at %.

Accordingly, a soft magnetic alloy having a saturation magnetic flux density of 170 emu/g or more and excellent amorphous or nanocrystalline formability may be obtained.

Here, the soft magnetic alloy according to an embodiment of the present invention may include at least one of Si and P. When the soft magnetic alloy according to an embodiment of the present invention includes both Si and P, Si and P may be included in an amount of 2 at % to 16 at %. When the amounts of Si and P are less than 2 at %, resistivity may be lowered and amorphous formability may be deteriorated. On the other hand, when the amounts of Si and P are greater than 16 at %, the content of Fe is relatively low, and thus saturation magnetic flux density may be reduced. When the soft magnetic alloy according to an embodiment of the present invention includes Si or P, the content of Si or P may range from 2 at % to 8 at %. When the content of Si or P is greater than 8 at %, the possibility of intermetallic compound formation may increase and saturation magnetic flux density may be lowered.

Among components of the soft magnetic alloy according to an embodiment of the present invention, C has strong atomic affinity with Fe. That is, C has a strong interatomic attraction with Fe, i.e., about two times that of B. Accordingly, when Fe and C are melted together, clustering and nucleation occur very easily in a super-cooled molten solution, and amorphous formability may be enhanced. Thus, when C is included in an amount of less than 2 at %, an amorphous formability enhancement effect may be low, and when C is included in an amount exceeding 8 at %, the possibility of intermetallic compound formation may increase and saturation magnetic flux density may be reduced.

Meanwhile, the soft magnetic alloy according to an embodiment of the present invention may further include, in addition to Fe, Si, P, and C, an additional element that acts as one of a metalloid-based element, a growth inhibitor, and a nucleation agent. The additional element includes, for example, at least one of B, N, Al, Ti, Zr, Hf, Nb, Ta, Cr, Mo, Co, and Ni.

Here, B may serve to enhance amorphous or nanocrystalline formability. That is, when Fe, Si, B, and C are melted in a molten metal and then cooled, the interatomic bonding force between Fe and C is higher than that between Fe and B, and thus C hinders crystallization between Fe and B. Accordingly, crystallization kinetics competition occurs due to a difference in interatomic bonding force between Fe—B and Fe—C, and thus high amorphous formability may be induced.

In addition, Cr acts as a growth inhibitor, enhances electrical resistance, and increases corrosion resistance by forming an oxide film on the soft magnetic alloy. For example, Cr may prevent corrosion that may occur in a process of preparing or drying a Fe-containing soft magnetic alloy.

However, when the additional element is included in an amount exceeding 10 at %, an additional compound may be produced, or raw material costs may be increased, and the content of Fe is relatively low, resulting in reduced saturation magnetic flux density.

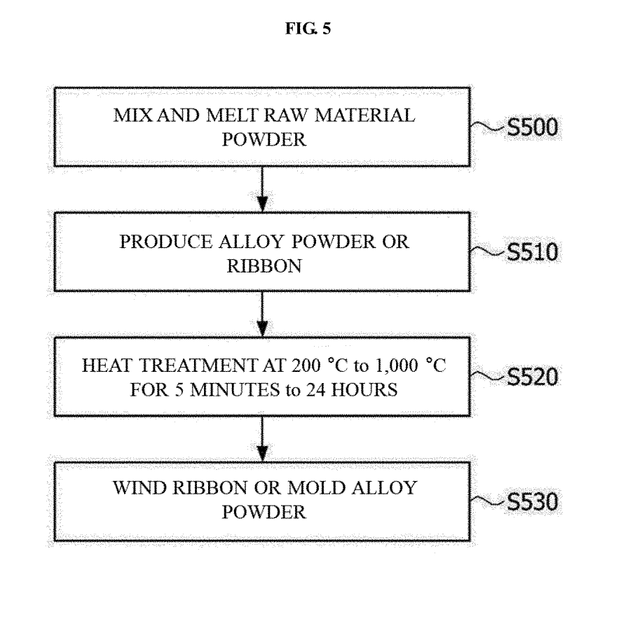

FIG. 5 is a flowchart illustrating a method of preparing a soft magnetic core, according to an embodiment of the present invention.

Referring to FIG. 5, raw material powder having the composition of Formula 1 is mixed in a molten metal, and melted at 1,500° C. to 1,900° C. (S500).

Subsequently, the resulting molten solution was rapidly cooled to thereby produce alloy powder or a ribbon (S510). To produce alloy powder, a gas including at least one of N₂ and Ar, or water may be sprayed onto the molten solution. In addition, to produce a ribbon, the molten solution may be put into a mold and rapidly cooled. Here, the ribbon may be an amorphous or nanocrystalline ribbon.

Next, the alloy powder or the ribbon is heat-treated at a temperature of 200° C. to 1,000° C. for 5 minutes to 24 hours (S520). The heat treatment process may be performed in a gas atmosphere including at least one of H₂, N₂, Ar, and NH₃ under the presence or absence of a magnetic field. At this time, when the heat treatment time is less than 5 minutes, an effect of enhancing soft magnetic characteristics by heat treatment may be deteriorated. In addition, when the heat treatment temperature is less than 200° C., the heat treatment time is increased, and thus economic efficiency is lowered, and when the heat treatment temperature is greater than 1,000° C., the alloy powder or the ribbon may be melted again.

Next, the heat-treated ribbon is wound, or the heat-treated alloy powder is molded, to form a soft magnetic core (S530).

Hereinafter, the present disclosure will be described in further detail with reference to the following examples and comparative examples.

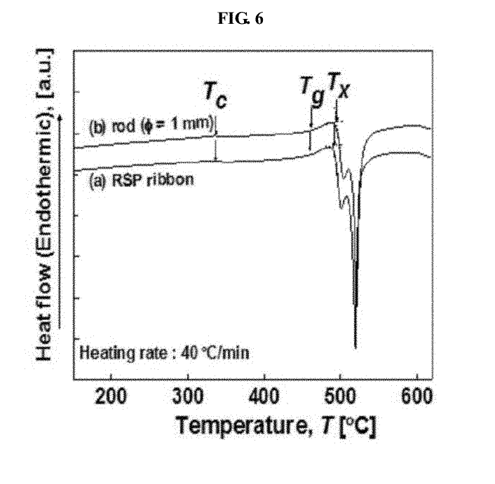

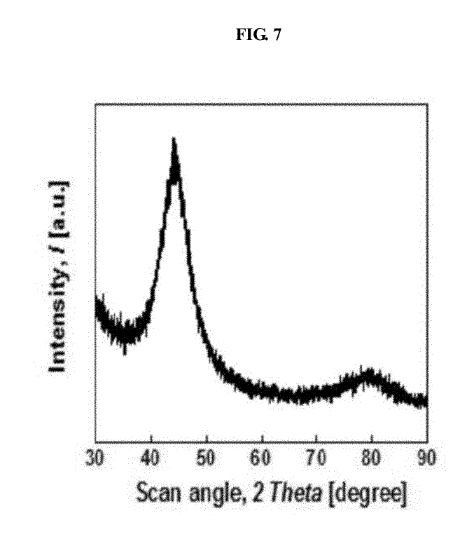

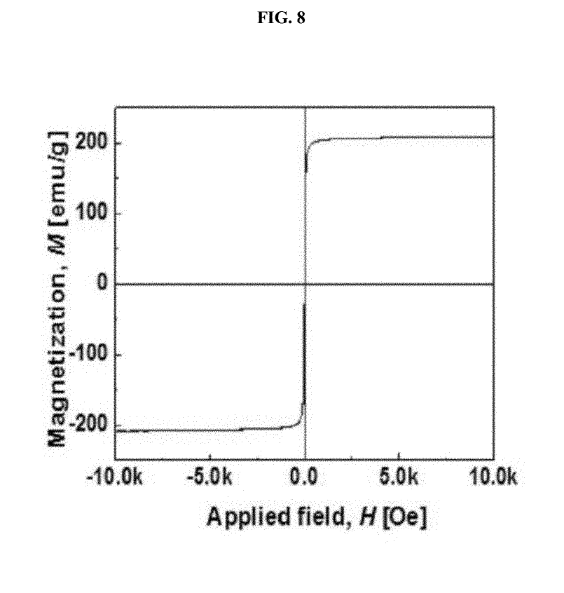

Table 1 shows the composition, saturation magnetic flux density (T), resistivity (μΩ·cm), and amorphous formability of each of soft magnetic alloys according to examples. Table 2 shows the composition, saturation magnetic flux density (T), resistivity (μΩ·cm), and amorphous formability of each of soft magnetic alloys according to comparative examples. FIG. 6 is a thermal analysis graph of a soft magnetic alloy prepared according to Example 1. FIG. 7 illustrates X-ray diffraction (XRD) pattern analysis of the soft magnetic alloy of Example 1. FIG. 8 illustrates saturation magnetic flux density of the soft magnetic alloy of Example 1.

Each of the soft magnetic alloys according to the examples and the comparative examples was prepared by melting metal powder according to each composition in a molten metal, producing alloy powder by cooling the resulting molten solution by spraying gas or water, and then heat-treating the alloy powder at 200° C. to 1,000° C.

The saturation magnetic flux density (T) of each of the soft magnetic alloys according to the examples and the comparative examples was measured using a vibrating sample magnetometer (VSM), and the resistivity (μΩ·cm) of each soft magnetic alloy was measured using a point probe. In addition, the amorphous formability of each of the soft magnetic alloys of the examples and the comparative examples was determined according to whether it is possible to form a ribbon or a cylindrical rod, and for this, thermal analysis and XRD pattern analysis were performed.

TABLE 1

| | | Saturation | | |
|---|---|---|---|---|
| Experi- | | magnetic | | |
| ment | Composition | flux density | Resistivity | Amorphous |
| No. | (at. %) | (emu/g) | (μΩ · cm) | formability |
| Example 1 | Fe₈₀Si₂P₈C₆B₄ | 195 | 160 | Passed (ribbon |
| | | | | and 1 mm-) |
| | | | | diameter cylinder |
| Example 2 | Fe₇₈Si₈C₆B₈ | 200 | 189 | Passed (ribbon) |
| Example 3 | Fe₈₂P₈C₆B₄ | 185 | 168 | Passed (ribbon) |
| Example 4 | Fe₈₀P₈C₆B₄Al₂ | 175 | 172 | Passed (ribbon |
| | | | | and 1 mm- |
| | | | | diameter cylinder) |
| Example 5 | Fe₈₀P₈C₆B₄Co₂ | 179 | 165 | Passed (ribbon |
| | | | | and 1 mm- |
| | | | | diameter cylinder) |

TABLE 2

| | | Saturation | | |
|---|---|---|---|---|
| | Composition | magnetic flux | Resistivity | |
| Experiment No. | (at. %) | density (emu/g) | (μΩ · cm) | Amorphous formability |
| Comparative | Fe₇₈Si₁₃B₉ | 165 | 120 | Passed (ribbon) |
| Example 1 | | | | |
| Comparative | Fe₇₆Si₉B₁₀P₅ | 158 | — | Passed (ribbon and 1.5 |
| Example 2 | | | | mm-diameter cylinder) |
| Comparative | Fe_{93.5 wt %}Si_{6.5 wt %} | 162 | 82 | Failed (amorphous |
| Example 3 | | | | formation is impossible) |

Referring to Tables 1 and 2 and FIGS. 6 to 8, it can be confirmed that the soft magnetic alloys of Examples 1 to 5 having the composition of Formula 1 have a saturation magnetic flux density of 170 emu/g or more and excellent amorphous formability, whereas the soft magnetic alloys of Comparative Examples 1 to 3 that are outside the above numerical range exhibit at least one of poor saturation magnetic flux density and poor amorphous formability. In particular, it can be confirmed that the case of Example 1 including all of Fe, Si, P, C, and B and having a composition that satisfies the conditions of Formula 1 exhibits high saturation magnetic flux density and excellent amorphous formability.

In addition, in the cases of Examples 1, 3, 4, and 5, since the content of Fe exceeds 78 at %, a total content of the remaining elements that contribute to amorphous formation (e.g., Si, P, C, B, Al, and Co) is less than 22 at %. Generally, as the content of Fe that contributes to saturation magnetic flux density is increased, the contents of the remaining elements that contribute to amorphous formability are decreased, and thus the saturation magnetic flux density and the amorphous formability have a trade-off relationship. However, according to the compositions of embodiments of the present invention, high saturation magnetic flux density may be obtained and amorphous formability may be maintained.

The soft magnetic alloy according to an embodiment of the present invention may be applied to various sheets for shielding an electromagnetic field. For example, the soft magnetic alloy according to an embodiment of the present invention may be applied to a soft magnetic sheet of a wireless power receiver for wireless charging, a shielding sheet for a radio frequency identification (RFID) antenna, and the like.

In addition, the soft magnetic alloy according to an embodiment of the present invention may be applied to a soft magnetic core for a transformer, a soft magnetic core for a motor, a magnetic core for an inductor, or a soft magnetic core for a wireless power transmitter for wireless charging. For example, the soft magnetic alloy according to an embodiment of the present invention may be applied to a magnetic core on which a coil is wound or a magnetic core in which a wound coil is accommodated.

Furthermore, the soft magnetic alloy according to an embodiment of the present invention may be variously applied to environmentally-friendly automobiles, high-performance electronic devices, and the like.

While the present invention has been described in detail with reference to exemplary embodiments, it will be understood by those of ordinary skill in the art that various changes and modifications may be made therein without departing from the spirit and scope of the present invention as defined in the appended claims.

1. A soft magnetic core comprising:
a nanocrystalline ribbon or an amorphous ribbon,
wherein the nanocrystalline ribbon or the amorphous ribbon is wound,
wherein the nanocrystalline ribbon or the amorphous ribbon consists of a soft magnetic alloy having a composition of Formula below:
FeₐX_{b}Y_{c}Z_{d} [Formula]
wherein, in the above Formula, X comprises at least one of silicon (Si) and phosphorus (P), Y comprises carbon (C), Z comprises at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

2. The soft magnetic core of claim 1, wherein each of the Si and the P is included so as not to exceed 8 at %.

3. The soft magnetic core of claim 2, wherein the b ranges from 4 at % to 12 at %, c ranges from 4 at % to 8 at %, and d ranges from 2 at % to 8 at %.

4. The soft magnetic core of claim 1, wherein the Z comprises B.

5. The soft magnetic core of claim 4, wherein the Z further comprises Al.

6. The soft magnetic core of claim 4, wherein the Z further comprises Co.

7. The soft magnetic core of claim 4, wherein the Z further comprises Cr.

8. The soft magnetic core of claim 1, wherein the soft magnetic alloy has a saturation magnetic flux density of 170 emu/g or more.

9. The soft magnetic core of claim 1, wherein the soft magnetic core is applied to at least one of a transformer, a motor, an inductor or a wireless power transmitter.

10. A shielding sheet for an antenna, the shielding sheet comprising a plurality of nanocrystalline ribbons which are stacked or a plurality of amorphous ribbons which are stacked,
wherein the plurality of nanocrystalline ribbons or the plurality of amorphous ribbons consist of a soft magnetic alloy having a composition of Formula below:
FeₐX_{b}Y_{c}Z_{d} [Formula]
wherein, in the above Formula, X comprises at least one of silicon (Si) and phosphorus (P), Y comprises carbon (C), Z comprises at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

11.-15. (canceled)

16. A method of forming a soft magnetic core, the method comprising:
preparing a molten solution by mixing and melting powder having a composition of Formula below;
producing a nanocrystalline ribbon or an amorphous ribbon by cooling the molten solution;
heat-treating the nanocrystalline ribbon or the amorphous ribbon; and
forming a soft magnetic core by winding the heat-treated nanocrystalline ribbon or the heat-treated amorphous ribbon:
FeₐX_{b}Y_{c}Z_{d} [Formula]
wherein, in the above Formula, X comprises at least one of silicon (Si) and phosphorus (P), Y comprises carbon (C), Z comprises at least one of boron (B), nitrogen (N), aluminum (Al), titanium (Ti), zirconium (Zr), hafnium (Hf), niobium (Nb), tantalum (Ta), chromium (Cr), molybdenum (Mo), cobalt (Co), and nickel (Ni), a ranges from 78 at % to 95.75 at %, b ranges from 2 at % to 16 at %, c ranges from 2 at % to 8 at %, and d ranges from 0.25 at % to 10 at %.

17. The method of claim 16, wherein the molten solution is cooled by spraying a gas comprising at least one of N₂ and Ar, or water.

18. The shielding sheet for the antenna of claim 10, wherein each of the Si and the P is included so as not to exceed 8 at %.

19. The shielding sheet for the antenna of claim 18, wherein the b ranges from 4 at % to 12 at %, c ranges from 4 at % to 8 at %, and d ranges from 2 at % to 8 at %.

20. The shielding sheet for the antenna of claim 10, wherein the shielding sheet is applied to a wireless power receiver.
